(19) United States
(12) Patent Application Publication
(10) Pub. No.: US 2021/0406805 A1
(43) Pub. Date: Dec. 30, 2021

(54) CLAIM ASSIGNMENT SYSTEM

(71) Applicant: State Farm Mutual Automobile Insurance Company, Bloomington, IL (US)

(72) Inventors: Garren King, Eureka, IL (US); Yuntao Li, Champaign, IL (US); Alexandria Pokorny, Normal, IL (US); Justin Devore, Atlanta, IL (US); Holly Kay Sanderson, Bloomington, IL (US); Victoria Ann Weintraub, Chandler, AZ (US); Patrick Thomas Carron, Orlando, FL (US); Sateesh K. Nallamothu, Normal, IL (US)

(21) Appl. No.: 17/364,266

(22) Filed: Jun. 30, 2021

Related U.S. Application Data
(60) Provisional application No. 63/046,443, filed on Jun. 30, 2020.

(51) Int. Cl. G06Q 10/06; G06Q 40/08; G06Q 10/10; G06N 20/00; G06N 5/04

(52) U.S. Cl. CPC G06Q 10/063112; G06Q 40/08; G06Q 10/06398; G06N 20/00; G06N 5/04; G06Q 10/105

(57) ABSTRACT

A claim assignment system can cause insurance claims to be assigned among different groups within an insurance company. The claim assignment system can have a rules engine and a machine learning engine that both recommend a group to which a claim can be assigned. The claim assignment system can be configured to select the group for the claim based on a recommendation from the machine learning model if a confidence level of the machine learning assignment recommendation meets or exceeds a threshold value, and otherwise select the group for the claim based on the assignment recommendation from the rules engine.

### RELATED APPLICATIONS

This U.S. patent application claims priority to provisional U.S. Patent Application No. 63/046,443, entitled “CLAIM ASSIGNMENT SYSTEM,” filed on Jun. 30, 2020, the entirety of which is incorporated herein by reference.

### TECHNICAL FIELD

The present disclosure relates to the assignment of insurance claims to groups within an insurance company, and more particularly to assigning insurance claims to groups based on a rules engine and/or one or more machine learning models.

### BACKGROUND

An insurance company can have numerous claim handlers, representatives, associates, or other individuals who can perform one or more tasks to process an insurance claim. For example, a claim handler can at least partially process an insurance claim by determining insurance policy coverage, determining liability, determining damage amounts, and/or performing other actions that may be involved in handling or processing the insurance claim overall.

The insurance company may group claim handlers, and/or other workers who can at least partially process insurance claims, into different groups. For example, the insurance company can divide claim handlers and other workers into different groups, segments, or tiers. Such different groups, segments, or tiers may, in some examples, correspond to different claim complexity levels, different claim types, and/or other claim attributes. When an insurance claim is submitted to the insurance company, the insurance claim can be assigned to a particular group, so that one or more workers in the group can process the insurance claim.

Insurance claims may vary in complexity. For example, when a driver backs a car out of a residential garage and a side mirror of the car hits the side of the garage, an insurance claim for damage to the side mirror may be relatively simple, because the claim involves only one driver and one car. However, another insurance claim associated with a multiple-car accident at a busy intersection may be relatively complex, because the claim may involve multiple participants, multiple vehicles, multiple insurance policies, and/or other complicating factors.

Accordingly, an insurance claim that is submitted to an insurance company can be assigned to one of many groups within the insurance company based on the complexity of the claim, attributes of the claim, and/or other factors. As an example, insurance claims can be assigned among a low-level tier that handles relatively simple claims, a mid-level tier that handles moderately complex claims, and a high-level tier that handles highly complex claims.

When an insurance claim is submitted, it may be initially unclear how complex the claim is, what issues may be involved in processing the claim, and/or to which group the claim should be assigned. Some insurance companies use static rules to determine where a claim should be assigned. For example, static rules may indicate that a claim should be assigned to a first group if the claim involves a single vehicle, but that a claim should be assigned to a second group if the claim involves more than one vehicle. However, in some cases, claims that are initially assigned to a group according to static rules may later be reassigned or transferred to a different group. For instance, static rules may indicate that a claim is to be assigned to a first group that handles relatively simple claims. However, at a later point in time, a worker of the first group may determine that the claim is more complicated than claims the first group normally handles, and the worker may request that the claim be transferred or reassigned to another group that generally handles more complex claims. In some cases, a claim may be transferred or reassigned between groups multiple times before a worker of a group begins to process the claim and/or the claim is fully processed.

Transfers or reassignments of claims between groups may introduce delays in claim processing, as in some cases claim processing does not begin, or is not completed, until a claim is reassigned from an initial group to a different group. An initial assignment of a claim to a group that does not ultimately process the claim can also lead to an inefficient use of resources. For example, computing resources, worker time, and/or other resources associated with an initially-assigned group may be wasted if a claim is ultimately transferred to a different group that actually processes the claim. Initially assigning claims to groups that later transfer the claims to other groups can also lead to increased network traffic and increased bandwidth usage as claims are transferred between computing devices associated with the groups.

The example systems and methods described herein may be directed toward mitigating or overcoming one or more of the deficiencies described above.

### SUMMARY

The systems and methods described herein can assign an insurance claim to a group within an insurance company, based at least in part on a machine learning assignment recommendation produced by a machine learning model and/or a rules engine assignment recommendation produced by a rules engine. If the machine learning assignment recommendation has a confidence level that meets or exceeds a threshold, the machine learning assignment recommendation can override the rules engine assignment recommendation, and the insurance claim can be assigned to a group based on the machine learning assignment recommendation. However, if the machine learning assignment recommendation has a confidence level that is below a threshold, or if the rules engine has been configured to at least temporarily take precedence over the machine learning model, the insurance claim can be assigned to a group based on the rules engine assignment recommendation. Assigning the insurance claim to a group based on a selected one of the machine learning assignment recommendation or the rules engine assignment recommendation, for example based on the confidence level of the machine learning assignment recommendation, can increase the likelihood that the assigned group will ultimately process the claim. Accordingly, the systems and methods described herein can decrease subsequent reassignments and transfers of claims between groups, and can cause claims to be processed more quickly and/or more efficiently due to higher likelihoods of claims being initially assigned to the groups that ultimately process the claims.

According to a first aspect, a method can include obtaining, by a claim assignment system, claim intake data associated with an insurance claim. The method can also include generating, by a rules engine of the claim assignment system based on the claim intake data, a rules engine assignment recommendation indicating a first group of workers, and generating, by a machine learning model of the claim assignment system based on the claim intake data, a machine learning assignment recommendation indicating a second group of workers and a confidence level associated with the machine learning assignment recommendation. The method can further include determining, by the claim assignment system, that the confidence level meets or exceeds a threshold value. The method can also include selecting, by the claim assignment system, the second group for the insurance claim, based on determining that the confidence level meets or exceeds the threshold value.

According to a second aspect, a claim assignment system can comprise a claim intake system, a rules engine, a machine learning model, and an assignment selector. The claim intake system can be configured to obtain claim intake data associated with an insurance claim. The rules engine can be configured to generate, based on the claim intake data, a rules engine assignment recommendation indicating a first group of workers. The machine learning model can be configured to generate, based on the claim intake data, a machine learning assignment recommendation indicating a second group of workers and a confidence level associated with the machine learning assignment recommendation. The assignment selector can be configured to determine that the confidence level meets or exceeds a threshold value, select the second group, based on determining that the confidence level meets or exceeds the threshold value, and output an indication that the insurance claim is to be assigned to the second group.

According to a third aspect, one or more non-transitory computer-readable media can store computer-executable instructions that, when executed by one or more processors, cause the one or more processors to perform operations. The operations can include generating, by a rules engine, and based on claim intake data associated with an insurance claim, a rules engine assignment recommendation indicating a first group selected from a set of candidate groups. The operations can also include generating, by a machine learning model, and based on the claim intake data, a machine learning assignment recommendation indicating a second group selected from the set of candidate groups and a confidence level. The operations can further include determining that the confidence level meets or exceeds a threshold value. The operations can also include selecting the second group for the insurance claim, based on determining that the confidence level meets or exceeds the threshold value.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows an example of a claim assignment system associated with an insurance company.

FIG. 2 shows an example of a decision tree that can be used in a rules engine.

FIG. 3 shows an example of a machine learning model in the claim assignment system.

FIG. 4 shows an example of a claim data pre-processor that can operate on claim intake data, before the claim intake data is provided to a rules engine and/or a machine learning model.

FIG. 5 shows a flowchart illustrating a first example method for selecting a group for a claim.

FIG. 6 shows a flowchart illustrating a second example method for selecting a group for a claim.

FIG. 7 shows a flowchart illustrating a third example method for selecting a group for a claim.

FIG. 8 shows an example system architecture for a computing device associated with the claim assignment system.

### DETAILED DESCRIPTION

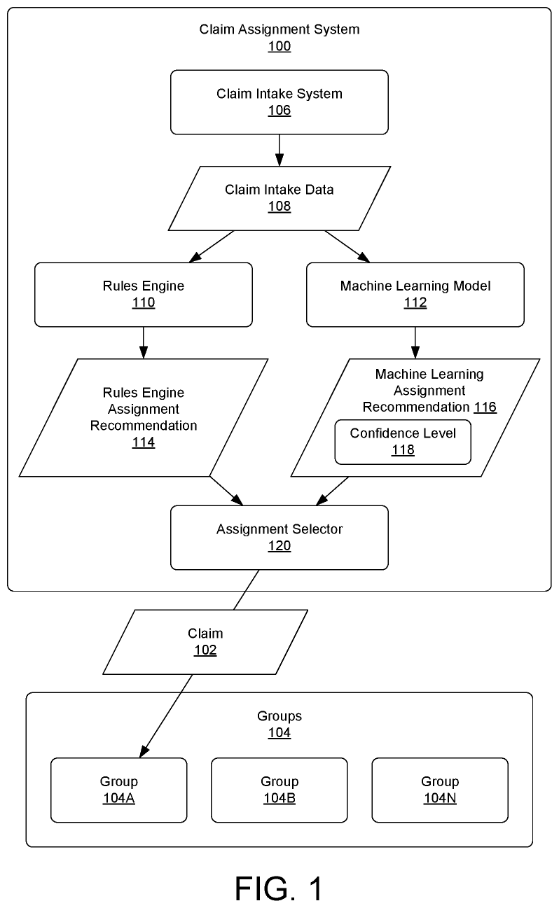

FIG. 1 shows an example of a claim assignment system 100 associated with an insurance company. The claim assignment system 100 can be configured to assign a claim 102, such as an insurance claim, to a group selected from a set of candidate groups 104 associated with the insurance company, or to output a claim assignment determination that indicates the selected group. The claim 102 can be an automobile insurance claim, a fire insurance claim, a flood insurance claim, a life insurance claim, a home insurance claim, or any other type of insurance claim submitted to the insurance company. The insurance company may have multiple groups 104 that process claims, and the claim assignment system 100 described herein can how to assign individual claims among the groups 104.

The groups 104 can include any number of groups, such as groups 104A, 104B . . . 104N (wherein “N” represents any number of groups greater than zero), as shown in FIG. 1. A group, such as group 104A or group 104B, may be a segment, tier, division, department, team, or other group of one or more individuals associated with the insurance company who can at least partially process claims. For example, groups 104 can include claim handlers, claims adjustors, specialists, and/or other types of workers who perform tasks to process claims. As a non-limiting example, an individual in a group can process an automobile insurance claim by performing tasks to determine whether parties have insurance coverage, determine how much insurance coverage the parties have, determine which party is at fault, determine if multiple parties are at fault in a comparative negligence situation, determine amounts to be paid to one or more parties, negotiate with insurers of other insured parties during subrogation situations, and/or take other actions to at least partially process and/or resolve the automobile insurance claim.

In some examples, a group can include multiple individuals, such as a team, division, or department within the insurance company. In other examples, a group can be a single individual, such as a worker who specializes in processing a certain type of claim. In some examples, the insurance company can assign workers to different groups 104 based on worker skill levels, worker experience levels, worker specialties, and/or other factors. Different groups 104 may also, or alternately, correspond to different complexity levels of claims, different types of claims, and/or other attributes of claims.

As a non-limiting example, for automobile and/or other property damage claims, an insurance company may have an “express” low-level group that is set up to handle relatively simple claims. However, the insurance company may also have a “tier 1” mid-level group that is set up to handle moderately complex claims, as well as a “tier 2” high-level group that is set up to handle the most complex claims. In some cases, the insurance company may assign workers who are relatively inexperienced to work in the “express” group, and assign workers who are more experienced and/or skilled to the higher-level tier 1 or tier 2 groups. In other examples, an insurance company may have any other number of groups 104 associated with any other number of tiers or segments.

As another non-limiting example, the insurance company may have different groups 104 that specialize in different types of claims. For instance, different groups 104 can exist for automobile insurance claims, fire insurance claims, flood insurance claims, life insurance claims, home insurance claims, and/or other types of claims.

As yet another non-limiting example, the insurance company may have one or more groups 104 that specialize in certain types of issues associated with processing claims. For example, the insurance company may have a group of workers who specialize in comparative negligence and/or subrogation issues. Accordingly, claims that may involve comparative negligence and/or subrogation issues can be handled by the comparative negligence and/or subrogation group, while other claims can instead be handled by other groups 104 whose workers may have less experience with comparative negligence and/or subrogation issues.

As shown in FIG. 1, the claim assignment system 100 can have, or be associated with, a claim intake system 106 that can collect and/or output claim intake data 108 associated with a claim, such as claim 102. In some examples, the claim intake system 106 can be part of the claim assignment system 100. In other examples, the claim intake system 106 can be separate from the claim assignment system 100, and the claim assignment system 100 can receive claim intake data 108 from the separate claim intake system 106.

The claim intake system 106 can collect or generate the claim intake data 108 based on data about a loss, such as information about an accident or other incident. The claim intake data 108 may be submitted directly, or indirectly, to the claim intake system 106 by customers of an insurance company, third-party claimants, insurance agents, call center representatives, claim handlers, and/or other individuals or entities. In some examples, the claim intake system 106 can be a computer-executable application, web-based portal, or other system with a user interface by which users can input data associated with a loss. The claim intake data 108 can include the data input by users, data inferred or derived from data input by users, and/or other types of data associated with the claim 102. In some examples, the claim intake data 108 can be, or include, a first notice of loss (FNOL), or other type of loss report associated with the claim 102.

As a non-limiting example, when an individual wants to report a loss and/or file the claim 102 with the insurance company, the individual can call or otherwise contact a representative of the insurance company, such as an agent, a call center representative, a claim handler, or other representative. The individual may provide information about the loss to the representative, for instance by describing details about an accident and/or by responding to questions posed by the representative. The representative can in turn input data into the claim intake system 106 based on the information provided by the individual. For example, the claim intake system 106 may have a user interface that the representative can use to enter information about a loss that the representative has received from a caller, enter information about the loss that the representative has inferred from information provided by the caller, and/or enter any other information about the loss. The claim intake system 106 may collect and/or generate the claim intake data 108 associated with the claim 102 based on such user input.

As another non-limiting example, the claim intake system 106 may have, or be associated with, a website, mobile application, or other system that an individual can use to directly report a loss and/or file the claim 102. For example, a customer of the insurance company may use a website or mobile application to directly file the claim 102 and provide corresponding information without communicating with a representative, and/or to upload pictures or other information associated with the claim 102. The claim intake system 106 may collect and/or generate the claim intake data 108 associated with the claim 102 based on such user input.

In some examples, the claim intake system 106 can also collect or generate the claim intake data 108 associated with the claim 102 based on data provided by other entities. For example, claim intake data 108 can include, or be based on, a damage estimate provided by a body shop that is associated with an automobile insurance claim.

The claim intake system 106 can provide the claim intake data 108, such as an FNOL or other loss report, and/or other information associated with the claim 102, to a rules engine 110 and/or at least one machine learning model 112. Although FIG. 1 shows an example that includes one machine learning model 112, in other examples the claim assignment system 100 can include multiple machine learning models. For example, the claim assignment system 100 can include multiple types of machine learning models, multiple machine learning models that have been trained on different sets of training data, and/or multiple machine learning models that vary in one or more other ways.

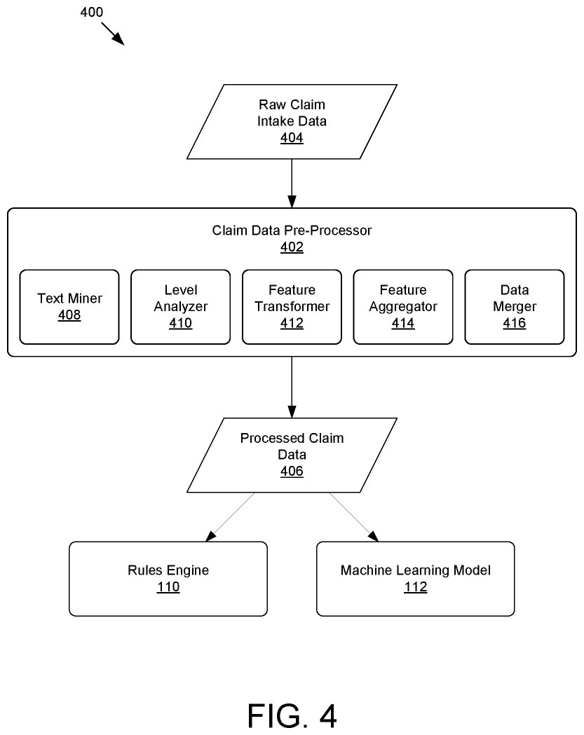

In some examples, the claim assignment system 100 can process, transform, and/or otherwise pre-process the claim intake data 108 before the claim intake data 108 is provided to the rules engine 110 and/or one or more machine learning models, as will be discussed further below with respect to FIG. 4. In other examples, the claim assignment system 100 can be configured to provide the claim intake data 108 directly from the claim intake system 106 to the rules engine 110 and/or one or more machine learning models, without first pre-processing the claim intake data 108.

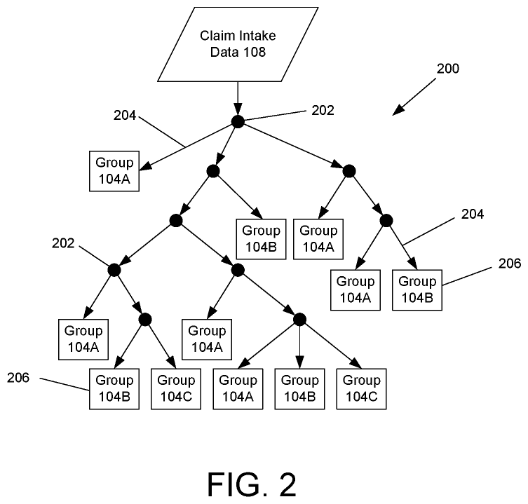

The rules engine 110 can use the claim intake data 108 to generate a rules engine assignment recommendation 114 associated with the claim 102. The rules engine assignment recommendation 114 can recommend a particular group, of the set of candidate groups 104, to which the claim 102 can be assigned. Generation of the rules engine assignment recommendation 114 by the rules engine 110 is discussed in more detail below with respect to FIG. 2.

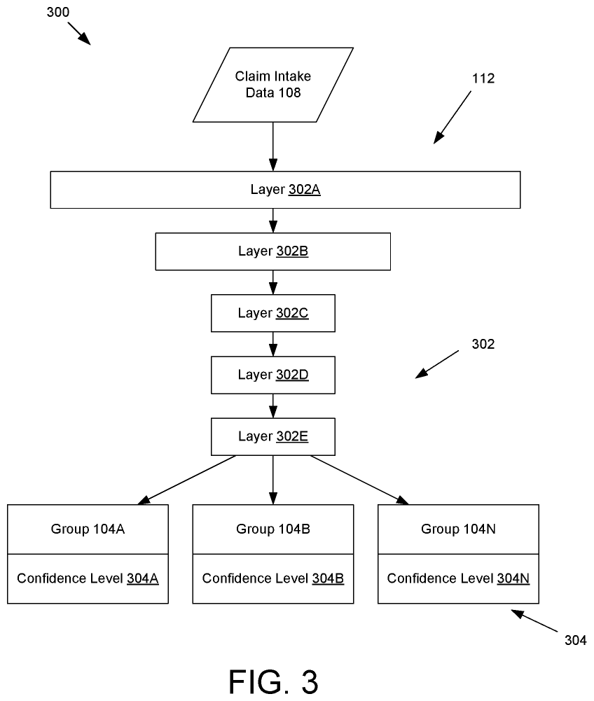

A machine learning model, such as the machine learning model 112 shown in FIG. 1, can use the claim intake data 108 to generate a machine learning assignment recommendation 116 associated with the claim 102. The machine learning assignment recommendation 116 can recommend a particular group, of the available candidate groups 104, to which the claim 102 can be assigned. The machine learning assignment recommendation 116 can include, or be associated with, a confidence level 118. Generation of the machine learning assignment recommendation 116, and the associated confidence level 118, by the machine learning model 112 is discussed in more detail below with respect to FIG. 3. In some examples, the claim assignment system 100 can include multiple machine learning models, and each of the machine learning models can use the claim intake data 108 to generate distinct machine learning assignment recommendations with corresponding confidence levels.

In some examples, the rules engine 110 and one or more machine learning models can process the claim intake data 108 substantially concurrently to generate corresponding assignment recommendations. For example, the rules engine 110 and the machine learning model 112 may execute substantially in parallel to generate corresponding assignment recommendations based on the claim intake data 108. In other examples, the rules engine 110 and the machine learning model 112 may execute at different times to generate corresponding assignment recommendations based on the claim intake data 108.

The claim assignment system 100 can have an assignment selector 120. The assignment selector 120 can be configured to select a particular group, of the set of candidate groups 104, for the claim 102, based on the rules engine assignment recommendation 114 or a machine learning assignment recommendation. For example, the assignment selector 120 may receive the rules engine assignment recommendation 114 generated by the rules engine 110 for the claim 102, the machine learning assignment recommendation 116 generated by the machine learning model 112 for the claim 102, and/or one or more other machine learning assignment recommendations generated by other machine learning models for the claim 102. The assignment selector 120 can compare the assignment recommendations generated by the rules engine 110 and/or one or more machine learning models, select one of the assignment recommendations for the claim 102, and select a group for the claim 102 based on the selected assignment recommendation. In some examples, the assignment selector 120 can be configured to directly assign the claim 102 to the selected group. In other examples, the assignment selector 120 can be configured to output a final claim assignment determination to another element of the claim assignment system, or an element outside the claim assignment system, that indicates the selected group for the claim 102.

For example, the assignment selector 120 may be a component of the claim intake system 106, or otherwise be associated with the claim intake system 106, such that the assignment selector 120 can provide a notification of the group selected for the claim 102 to the claim intake system 106. The claim intake system 106 can then assign the claim 102 to the group selected by the assignment selector 120, or provide an indication of the selected group to an outside system that provided the claim intake data 108 to the claim intake system 106. As another example, an outside system can call the claim assignment system 100 to request an indication of which group the claim assignment system 100 would select for a particular claim based on associated claim intake data 108, and the assignment selector 120 can cause a notification of the selected group to be returned to the outside system that called the claim assignment system 100. For example, the assignment selector 120 and/or other elements of the claim assignment system 100 can be associated with one or more Application Programming Interfaces (APIs), and/or one or more microservices, that allow other systems to call individual elements and/or operations of the claim assignment system 100.

In some examples, the assignment selector 120 can be configured to choose between following the rules engine assignment recommendation 114 or the machine learning assignment recommendation 116 for the claim 102. In some situations, the rules engine assignment recommendation 114 and the machine learning assignment recommendation 116 may both recommend assigning the claim 102 to the same group. Accordingly, in these situations, the assignment selector 120 can determine that the claim 102 should be assigned to the group recommended in either, or both, the rules engine assignment recommendation 114 or the machine learning assignment recommendation 116. However, in other situations, the rules engine assignment recommendation 114 and the machine learning assignment recommendation 116 for the claim 102 may recommend that the claim 102 be assigned to different groups 104. The assignment selector 120 can accordingly be configured to determine whether the claim 102 should be assigned to the group recommended in the rules engine assignment recommendation 114 or to the group recommended in the machine learning assignment recommendation 116.

In some examples, the assignment selector 120 can be configured to select a group for the claim 102 based on the rules engine assignment recommendation 114, unless the confidence level 118 of the machine learning assignment recommendation 116 is at or above a predefined threshold. For example, the assignment selector 120 can be configured to select, for the claim 102, the group recommended in the rules engine assignment recommendation 114 by default, but to instead select the group recommended in the machine learning assignment recommendation 116 if the confidence level 118 of the machine learning assignment recommendation 116 meets or exceeds a predefined threshold. Alternatively, the assignment selector 120 can be configured to select the group for the claim 102 based on the machine learning assignment recommendation 116 by default, but to instead select the group for the claim 102 based on the rules engine assignment recommendation 114 if the confidence level 118 of the machine learning assignment recommendation 116 is below a predefined threshold.

In some examples, the assignment selector 120 may be configured to use different predefined threshold values, based on the particular group identified in the machine learning assignment recommendation 116. As a non-limiting example, the assignment selector 120 may be configured to select, for the claim 102, the group recommended in the machine learning assignment recommendation 116 if the machine learning assignment recommendation 116 recommends assigning the claim 102 to an “express” tier group at a confidence level of at least 95%, recommends assigning the claim 102 to a “tier 1” group at a confidence level of at least 85%, or recommends assigning the claim 102 to a “tier 2” group at a confidence level of at least 80%. Accordingly, in this example, if the machine learning assignment recommendation 116 recommends that the claim 102 be assigned to the “tier 1” group at a confidence level of 82%, the assignment selector 120 can determine that the confidence level 118 of the machine learning assignment recommendation 116 is below the 85% predefined threshold value for the “tier 1” group, and the assignment selector 120 can instead choose to assign the claim 102 to the group identified in the rules engine assignment recommendation 114.

As discussed above, in some examples the claim assignment system 100 can include multiple machine learning models that each produce different machine learning assignment recommendations for the claim 102 that are similar to the machine learning assignment recommendation 116 shown in FIG. 1. In these examples, the assignment selector 120 can be configured to compare multiple machine learning assignment recommendations against each other, and/or against the rules engine assignment recommendation 114, to determine which assignment recommendation to follow for the claim 102.

As a non-limiting example, the assignment selector 120 may determine, from a set of machine learning assignment recommendations for the claim 102, if any the machine learning assignment recommendations have confidence levels above a particular threshold value or above different threshold values associated with corresponding machine learning models that produced the machine learning assignment recommendations. In this example, if at least one of the machine learning assignment recommendations has a confidence level above a corresponding threshold value, the assignment selector 120 may select the group recommended by that machine learning assignment recommendation instead of a group recommended by the rules engine assignment recommendation 114. In some examples, if multiple machine learning assignment recommendations have confidence levels that are above associated threshold values, the assignment selector 120 may be configured to follow the machine learning assignment recommendation with the highest confidence level, or otherwise perform one or more comparison operations to determine which one of the machine learning assignment recommendations to follow.

As another non-limiting example, the assignment selector 120 can be configured with a hierarchy of the rules engine 110 and multiple machine learning models. The assignment selector 120 perform a series of comparison operations on the rules engine assignment recommendation 114 and/or multiple machine learning assignment recommendations based on the hierarchy, to select one of the assignment recommendations to follow. For instance, the hierarchy may cause the assignment selector 120 to perform a first comparison operation to select between the rules engine assignment recommendation 114 and a first machine learning model assignment recommendation generated by a first machine learning model that is lowest in the hierarchy. The assignment selector 120 can next perform a second comparison operation to select between the assignment recommendation (either the rules engine assignment recommendation 114 or the first machine learning model assignment) and a second machine learning model assignment recommendation generated by a second machine learning model that is higher than the first machine learning model in the hierarchy. The assignment selector 120 can perform one or more subsequent comparison operations to compare assignment recommendations selected during the previous comparison operation against a machine learning assignment recommendation generated by the next-highest machine learning model in the hierarchy. Accordingly, the assignment selector 120 can select a final assignment recommendation based on a series of comparison operations. In some situations, if the machine learning model assignment recommendations have relatively low confidence levels, the assignment selector 120 may select the rules engine assignment recommendation 114 during each of the comparison operations, such that the assignment selector 120 ultimately determines to follow the rules engine assignment recommendation 114. However, in other situations, the assignment selector 120 may ultimately determine to follow one of the machine learning assignment recommendations after comparing them based on a predetermined hierarchy of machine learning models.

As yet another non-limiting example, the assignment selector 120 may be configured to select an assignment recommendation, from a set of candidate assignment recommendations that includes the rules engine assignment recommendation 114 and multiple machine learning assignment recommendations, based on hierarchies associated with rules engine 110 and machine learning models, and/or the groups 104. For example, the groups 104 can include an “express” low-level group, a tier 1″ mid-level group, a “tier 2” high-level group. In this example, the assignment selector 120 can initially determine that two assignment recommendations, associated with the rules engine 110 and a low-priority machine learning model, indicate the low-level group. The assignment selector 120 can determine if any machine learning model assignment recommendations produced by higher-priority machine learning models recommend assigning the claim to the tier 1 group or the tier 2 group, with at least a threshold confidence level. If none of the other machine learning model assignment recommendations recommend assigning the claim 102 to a higher tier group with at least a threshold confidence level, the assignment selector 120 may determine to assign the claim 102 to the low-level “express” group. However, if a machine learning model assignment recommendation produced by a higher-priority machine learning model does recommend assigning the claim 102 to a higher-level group, with at least a threshold confidence level, the assignment selector 120 can determine that the claim 102 should be assigned to the higher-level group.

In some examples, the assignment selector 120 can be configured to at least temporarily follow rules engine assignment recommendations over machine learning assignment recommendations during certain periods of time and/or for certain types of claims, regardless of the confidence levels of the machine learning assignment recommendations. For instance, the assignment selector 120 can be configured to follow rules engine assignment recommendations instead of machine learning assignment recommendations at least temporarily in response to changes to the rules engine 110 that change a rule, add a rule, delete a rule, or otherwise change how the rules engine 110 generates rules engine assignment recommendations.

As a non-limiting example, the insurance company may adjust the rules engine 110 to generate rules engine assignment recommendations that recommend assigning certain types of claims to a new group that was not previously part of a candidate set of groups 104 to which claims could be assigned. As another non-limiting example, the insurance company may adjust the rules engine 110 to change from recommending sending claims associated with recreational vehicles (RVs) to an express group, to instead send RV-related claims to a tier 1 group. As yet another non-limiting example, the insurance company may adjust the rules engine 110 to temporarily recommend that claims associated with a natural disaster be assigned to a particular group. As still another non-limiting example, the insurance company may alter the static rules used by the rules engine 110 in any other way. The assignment selector 120 can also be configured to follow rules engine assignment recommendations temporarily based on such changes to the rules engine 110, and/or until the machine learning model 112 is re-trained over a period of time based on new rules engine assignment recommendations produced by the altered rules engine 110. Training of the machine learning model 112 is discussed in more detail below with respect to FIG. 3.

Accordingly, the claim assignment system 100 can be configured to at least temporarily override machine learning assignment recommendations generated by the machine learning model 112, and/or other machine learning models, with rules engine assignment recommendations generated by the rules engine 110. In some examples, the rules engine 110 can be configured to add an override flag, or other override indicator, to rules engine assignment recommendations that are to override corresponding machine learning assignment recommendations, such that the assignment selector 120 can prioritize rules engine assignment recommendations that include such override indicators over corresponding machine learning assignment recommendations. In other examples, the assignment selector 120 can be directly reconfigured to override machine learning assignment recommendations from the machine learning model 112, and/or other machine leaning models, with rules engine assignment recommendations from the rules engine 110 for a certain period of time, for certain types of claims, and/or until the assignment selector 120 is again configured to follow machine learning assignment recommendations when confidence levels of the machine learning assignment recommendations meet or exceed threshold values.

As a non-limiting example of a situation in which the claim assignment system 100 can be configured to at least temporarily use rules engine assignment recommendations instead of machine learning assignment recommendations, the insurance company may set up a new group to process hurricane-related claims, or reassign an existing group to process hurricane-related claims, after a hurricane occurs. The insurance company may also adjust static rules in the rules engine 110 so that rules engine assignment recommendations for hurricane-related claims recommend assigning the hurricane-related claims to the new, or newly designated, hurricane group. However, because the hurricane group is new, or was not previously designated to handle hurricane-related claims, historical data previously used to train the machine learning model 112, and/or other machine learning models, would not have indicated that previous hurricane-related claims were processed by the new hurricane group. The machine learning model 112, and/or other machine leaning models, may accordingly have been trained to generate machine learning assignment recommendations that would recommend assigning the hurricane-related claims among a previous set of candidate groups 104, and may not recommend assigning any such claims to the new hurricane group.

In this example, to avoid the use of machine learning assignment recommendations that may not yet recommend assigning claims to the new hurricane group, the insurance company can configure the assignment selector 120 to follow rules engine assignment recommendations for claims flagged by the rules engine 110 or other elements as being hurricane-related, and/or for a period of time following the hurricane. Accordingly, the assignment selector 120 can follow the rules engine assignment recommendations and assign hurricane-related claims to the hurricane group, even if machine learning assignment recommendations would have assigned those claims to other groups 104 at confidence levels that meet or exceed a threshold value.

As claims are assigned to the hurricane group according to the rules engine assignment recommendations, assignments of the claims to the hurricane group can become part of historical data that can be used to re-train the machine learning model 112, and/or other machine learning models, to recommend assigning hurricane-related claims to the hurricane group. Training of a machine learning model is discussed in more detail below with respect to FIG. 3. For example, the machine learning model 112 can be trained to, over time, recommend assigning hurricane-related claims to the hurricane group, to substantially replicate the rules engine assignment recommendations for those claims. Once the machine learning model 112 has been re-trained using new training data indicating assignments of claims to groups 104 based on adjustments to the rules engine 110, the assignment selector 120 can be configured to again follow machine learning assignment recommendations produced by the machine learning model 112 if confidence levels of the machine learning assignment recommendations meet or exceed corresponding threshold values.

Overall, the claim assignment system 100 can be configured to assign claims among groups 104 based on machine learning recommendations if the machine learning recommendations have confidence levels that meet or exceed threshold values, but to otherwise assign claims to groups based on rules engine assignment recommendations. In some examples, if the confidence level 118 of the machine learning assignment recommendation 116 for the claim 102 is at or above a threshold value, the group identified by the machine learning assignment recommendation 116 may be more likely to ultimately process the claim 102 than a different group identified by the corresponding rules engine assignment recommendation 114 for the claim 102. In these examples, the claim assignment system 100 can assign the claim 102 to the group identified in the machine learning assignment recommendation 116. In other examples, if the confidence level 118 of the machine learning assignment recommendation 116 for the claim 102 is below the threshold value, the group identified by the rules engine assignment recommendation 114 for the claim 102 may be more likely to ultimately process the claim 102 than the group identified in the machine learning assignment recommendation 116. In these examples, the claim assignment system 100 can assign the claim 102 to the group identified in the rules engine assignment recommendation 114.

Accordingly, the claim assignment system 100 can select between following rules engine assignment recommendations and machine learning assignment recommendations for claims, to increase the likelihood that the claims are initially assigned to the groups that ultimately process the claims and to decrease the likelihood that claims are later transferred between groups. The claim assignment system 100 can thereby cause claims to be processed more quickly and/or more efficiently by the groups 104.

In addition, the claim assignment system 100 can result in lower usage of computing resources and network bandwidth overall. For example, if a claim were assigned to group 104B initially, but later needed to be transferred to group 104A, there may be network messages associated with the transfer of the claim sent between computing devices associated with group 104A and group 104B. However, although a rules engine assignment recommendation may recommend assigning the claim to group 104B, the claim assignment system 100 may determine based on a machine learning assignment recommendation that the claim should instead be initially assigned to group 104A. Accordingly, network messages associated with the transfer of the claim between groups 104A and 104B can be avoided, and usage of network bandwidth can be reduced overall. Similarly, usage of processing cycles, memory, and/or other computing resources of computing devices associated with group 104B can be avoided by initially assigning the claim to group 104B and then later re-assigning the claim to group 104A.

In some examples, other systems may call the claim assignment system 100 to obtain an indication of which group the assignment selector 120 has selected for a claim based on final claim intake data, or would select for a claim based on preliminary claim intake data. As a non-limiting example, during a call in which a claimant is providing information about a claim to a customer service representative, a system used by the customer service representative may provide partial or preliminary claim intake data to the claim assignment system 100. The assignment selector 120 can choose between a rules engine assignment recommendation and one or more machine learning assignment recommendations generated based on the partial or preliminary claim intake data, and the claim assignment system 100 can return notification of the group identified in the selected assignment recommendation to the system used by the customer service representative. The customer service representative may accordingly transfer the call to a worker associated with the identified group, or request that a worker associated with the identified group join the call, because the claim assignment system 100 indicates a strong likelihood that the claim will ultimately be assigned to the identified group. Similarly, once a customer service representative has received all of the claim intake data from a caller, the customer service representative can request that the claim assignment system 100 provide an indication of a group selected by the claim assignment system 100 based on the full claim intake data, such that the customer service representative can transfer the caller to the group that the claim assignment system 100 selects for the claim.

As another-non-limiting example, an outside police report collection system can request that the claim assignment system 100 provide notifications when the claim assignment system 100 determines that a claim is to be assigned to one or more groups that routinely use police reports to process claims. For example, if the groups 104 include an express group that handles relatively simple claims that do not normally involve police reports, and a high-level group that handles more complex claims that do commonly involve requesting and processing police reports, the claim assignment system 100 can be configured to notify the outside police report collection system when the claim assignment system 100 determines that a claim is to be assigned to the high-level group. Accordingly, upon such a notification, the outside police report collection system can begin processes to request a police report associated with the claim, such that the police report may be received and available by the time the high-level group begins processing the claim.

As discussed above, the claim assignment system 100 can use assignment recommendations generated by the rules engine 110 and/or one or more machine learning models to select a group for the claim 102. Generation of the rules engine assignment recommendation 114 by the rules engine 110 is discussed in more detail below with respect to FIG. 2, while generation of a machine learning assignment recommendation by a machine learning model is discussed in more detail below with respect to FIG. 3.

FIG. 2 shows a non-limiting example of a decision tree 200 that can be used in the rules engine 110 to generate the rules engine assignment recommendation 114. The rules engine 110 may be based on predefined logic, such as a predefined decision tree or a predefined algorithm, that analyzes attributes of the claim intake data 108 associated with the claim 102 to generate the rules engine assignment recommendation 114 that identifies a recommended group for the claim 102.

The decision tree 200 can have decision nodes 202 at which the decision tree 200 divides into two or more branches 204 based on attributes in the claim intake data 108. The decision nodes 202 may correspond to static rules the rules engine 110 is configured to use to generate the rules engine assignment recommendation 114. For example, decision nodes 202 may divide into branches 204 based on a number of vehicles involved in an accident, a location of the accident, a number of different insurance companies associated with vehicles involved in the accident, and/or other factors indicated in the claim intake data 108. Branches 204 may lead to one or more subsequent decision nodes 202, or to end nodes 206 that identify groups that can be indicated by the rules engine assignment recommendation 114. Accordingly, the rules engine 110 may follow branches 204 of the decision tree 200 to a particular end node of the end nodes 206, based on information in the claim intake data 108, and generate the rules engine assignment recommendation 114 to identify the group associated with the particular end node.

As a non-limiting example, if the claim intake data 108 indicates that only one vehicle is associated with the claim 102, the rules engine 110 may, at decision nodes 202, follow branches 204 of a predefined decision tree that terminate at an end node indicating that the claim 102 should be assigned to group 104A. In this example, the group 104A may be an “express” group that has been set up to process relatively simple claims. The rules engine 110 can therefore generate the rules engine assignment recommendation 114 to include an identifier of the “express” group as the recommended group for the claim 102. However, if the claim intake data 108 instead indicates that multiple vehicles were involved in an accident associated with the claim 102, and/or indicates other information that cause the rules engine 110 to follow different branches 204 of the predefined decision tree at decision nodes 202, the rules engine 110 may follow branches 204 that lead to a different end node indicating that the claim 102 should be assigned to group 104B. In this example, the group 104B may be a “tier 1” group that has been set up to process more complex claims than the simpler claims processed by the “express” group. Accordingly, the rules engine 110 may generate the rules engine assignment recommendation 114 to include an identifier of the “tier 1” group as the recommended group for the claim 102.

Overall, the rules engine 110 may follow static rules, in some examples represented by a static decision tree as shown in FIG. 2, to generate the rules engine assignment recommendation 114 for the claim 102. Machine learning models, such as machine learning model 112 may, instead of using static rules, generate machine learning assignment recommendations for the claim 102 more dynamically, for instance by being trained on historical data as discussed in more detail below with respect to FIG. 3.

FIG. 3 shows a non-limiting example 300 of a machine learning model, such as machine learning model 112, in the claim assignment system 100. In various examples, a machine learning model can be based on convolutional neural networks, recurrent neural networks, other types of neural networks, nearest-neighbor algorithms, regression analysis, Gradient Boosted Machines (GBMs), Random Forest algorithms, deep learning algorithms, and/or other types of artificial intelligence or machine learning frameworks. As discussed above, in some examples the claim assignment system 100 can include multiple machine learning models, such as different types of machine learning models or machine learning models that are trained based on different data sets.

In some examples, a machine learning model can be trained using a supervised machine learning approach, based on training set of data that includes numerous data points associated with claims, groups 104, previous assignments of claims to groups 104, and/or other types of data points. Such data points can be referred to as “features” for machine learning algorithms. Targets, goals, or optimal outcomes can be established for assignments of claims to groups 104, and supervised learning algorithms can determine weights for different features, and/or for different combinations of features, from the training set that optimize prediction of the target outcomes. For instance, underlying machine learning algorithms can determine which combinations of features in the training set are statistically more relevant to predicting target outcomes, and/or determine weights for different features, and can thus prioritize those features in relative relation to each other. After a machine learning model has been trained, the trained machine learning model can be used to infer probabilistic outcomes when the trained machine learning model is presented with new data of the type on which it was trained.

For example, the machine learning model 112 can be trained to predict which group the claim 102 should be assigned to, based on historical data about which groups 104 processed previous claims. As discussed further below, the historical data may indicate which groups 104 actually processed previous claims after any reassignments of the claims between groups 104. The machine learning model 112 can thus be trained to predict which groups are the best destinations for claims, such as the groups 104 that actually ultimately processed the claims. The training can cause the machine learning model 112 to generate the machine learning assignment recommendation 116 for the claim 102 to include an identifier of the group predicted by the machine learning model 112 as being the most likely to ultimately process the claim 102, and thereby the best destination for the claim 102.

In some examples, the machine learning model 112 can be trained using supervised machine learning according to a training set of data, until the machine learning model 112 can accurately make predictions that match a validation set of data to at least a threshold degree of accuracy. After the machine learning model 112 has been trained, the machine learning model 112 can also, or alternately, be tested to confirm that it can make predictions that match, to a threshold degree of accuracy, a test set of data that was not included in the training set or validation set. For example, given a set of twelve months of historical data about which groups 104 processed previous claims, random sets of data from the first ten months of data can be used as training sets and validations sets during training of the machine learning model 112, and the final two months of data can be used as test data.

In some examples, the historical data used to train the machine learning model 112 can identify groups 104 that were assigned to handle the previous claims at points in time at which processing of the previous claims began, or were about to begin. For instance, the historical data can indicate which groups 104 were assigned to process claims at points in time when workers in the groups 104 begin contacting customers or claimants associated with the claims, or otherwise began performing other substantive actions to process the previous claims. Accordingly, by training the machine learning model 112 based on the last groups 104 to which previous claims were assigned (before substantive actions were taken to process those previous claims), the machine learning model 112 can be trained to recommend assigning claims to those final groups 104.

As an example, a previous claim may have initially been assigned to the first group 104A shown in FIG. 1 by the rules engine 110 or other process. However, the historical data may instead indicate that the previous claim was ultimately processed by the second group 104B shown in FIG. 1, for example if the claim was reassigned one or more times until it was ultimately assigned to, and processed by, the second group 104B. In this example, the machine learning model 112 can be trained based on historical data indicating that the second group 104B was the “correct” or “true” destination for the claim, even though the claim may have been initially assigned to the first group 104A.

As shown in FIG. 3, in some examples, a machine learning model may be a neural network with one or more layers 302. Each of the layers 302 can include one or more neurons, and the output of neurons in one layer can be used as input to neurons of the next layer. Neurons can be trained to predict which group should be assigned the claim 102, as discussed above, based on historical data identifying groups 104 that processed previous claims. In some examples, different layers 302 may have the same or different numbers of neurons. For instance, in some examples, a machine learning model may have a first layer 302A with 128 neurons, a second layer 302B with 64 neurons, a third layer 302C with 64 neurons, a fourth layer 302D with 64 neurons, and a fifth layer 302E with 64 neurons. However, in other examples, a machine learning model may have fewer, or more than five layers 302. Additionally, in other examples, a machine learning model may have any other number of neurons at each layer.

The number of layers 302, and/or the number of neurons at each of the layers 302, may be hyperparameters that can be selected and/or configured by users in a machine learning model. In some examples, the hyperparameters can be selected based on a trade-off between execution speed and accuracy. For example, a machine learning model with five layers 302 may produce predictions at a speed and an accuracy level that is acceptable to a user, while a machine learning model with six layers 302 may produce slightly more accurate predictions, but take exponentially longer to execute. Accordingly, if a user determines in this example that the relatively small increase in accuracy produced by the extra layer is not worth the longer execution time, the user may choose to use five layers 302 instead of six layers 302 in a machine learning model. In some examples, learning rates specifying how long to train each iteration of a machine learning model can also, or alternately, be selectable and/or configurable hyperparameters of the machine learning model. In some examples in which the claim assignment system 100 includes multiple machine learning models, different machine learning models may have different numbers of layers, different numbers of neurons in individual layers, and/or be based on other types of machine learning frameworks.

A machine learning model can generate a machine learning assignment recommendation by including an identifier of the group predicted by the machine learning model as being the best destination for the claim 102. The machine learning model can also include an indicator of a confidence level in, or with, the machine learning assignment recommendation, as discussed above with respect to FIG. 1. For example, the confidence level 118 of the machine learning assignment recommendation 116 can be a probability, or other confidence level, of a predicted group being the best destination for the claim 102.

In some examples, a machine learning model can generate distinct confidence levels 304 associated with different candidate groups 104 that can potentially be assigned the claim 102. For example, as shown in FIG. 3, the machine learning model can generate different confidence levels 304, such as confidence levels 304A, 304B, . . . 304N (wherein “N” represents any number of confidence greater than zero), associated with different groups 104. The machine learning model can select the confidence level associated with a selected one of the candidate groups 104 as the confidence level for the machine learning assignment recommendation produced by the machine learning model.

As a non-limiting example, if 75% of the predictions generated by the neurons in the lowest layer of a neural network machine learning model indicate that the claim 102 should be assigned to the first group 104A shown in FIG. 1, the confidence level 304A associated with the first group 104A can be 75%. Similarly, if 25% of the predictions generated by the neurons in the lowest layer indicate that the claim 102 should be assigned to the second group 104B, the confidence level 304B associated with the second group 104B can be 25%.

In examples in which a machine learning model generates confidence levels 304 associated with multiple candidate groups 104, the machine learning model can generate a machine learning assignment recommendation based on the particular group that is associated with the highest confidence level among the candidate groups 104. For instance, in the above example in which the first group 104A is associated with a confidence level 304A of 75% and the second group 104B is associated with a confidence level 304B of 25%, the machine learning model 112 can select the first group 104A as the best destination for the claim 102 based on the higher confidence level associated with the first group 104A. The machine learning model 112 can accordingly generate the machine learning assignment recommendation 116 to include an identifier of the first group 104A, and can include the 75% confidence level 304A associated with the first group 104A as the confidence level 118 of the machine learning assignment recommendation 116.

In other examples, a machine learning model may generate a single prediction of which group among a set of candidate groups 104 is the best destination for the claim 102, and can identify the confidence level associated with that prediction. In these examples, the machine learning model can output a machine learning assignment recommendation including information that identifies the predicted group and the corresponding confidence level.

As discussed above, in some examples the claim assignment system 100 can include multiple machine learning models. In these examples, individual machine learning models can individually generate distinct machine learning assignment recommendation with associated confidence levels, as described above with respect to FIG. 3.

As discussed above with respect to FIGS. 1-3, the rules engine 110 and one or more machine learning models can process the claim intake data 108 to generate assignment recommendations for the claim 102. In some examples, the claim assignment system 100 may at least partially pre-process the claim intake data 108 before providing the claim intake data 108 to the rules engine 110 and the one or more machine learning models, as discussed below with respect to FIG. 4.

FIG. 4 shows an example 400 of a claim data pre-processor 402. The claim data pre-processor 402 can be part of the claim assignment system 100, or be associated with the claim assignment system 100. The claim data pre-processor 402 can be configured to process, transform, and/or otherwise operate on claim intake data 108, before the claim intake data 108 is provided to the rules engine 110 and/or one or more machine learning models. For example, the claim intake system 106 may output claim intake data 108 as raw claim intake data 404 that may include structured data and/or unstructured data. The claim data pre-processor 402 can convert the raw claim intake data 404 into processed claim data 406 that can be provided to the rules engine 110 and/or one or more machine learning models for further processing as discussed above with respect to FIGS. 1-3.

The raw claim intake data 404 may be an Extensible Markup Language (XML) file, JavaScript Object Notation (JSON) file, or other type of file. The raw claim intake data 404 may include attribute-value pairs (AVPs), also known as key-value pairs, that indicate values for specified attributes or keys. As a non-limiting example, raw claim intake data 404 can include an AVP indicating that a location of an accident was in the state of Illinois, and another AVP with a binary value indicating whether the accident involved bodily injury. In some cases, the AVPs can be nested, such that a value for an attribute can include a nested set of one or more other AVPs. For example, an AVP associated with participants in an accident may have a value that includes a first set of nested AVPs that indicates information about a first participant, and may also include a second set of nested AVPs that indicates information about a second participant.

In some examples, the rules engine 110 and/or one or more machine learning models may not be configured to natively interpret the raw claim intake data 404. For example, the rules engine 110 and/or the machine learning model 112 may not be configured to process location information based on names of cities or states that may be present in raw claim intake data 404, but may be configured to process location information in a numerical form that maps to corresponding city or state names. Accordingly, the claim data pre-processor 402 can perform one or more operations to convert the raw claim intake data 404 into processed claim data 406 that can be provided to, and used by, the rules engine 110 and/or the machine learning model 112. The claim data pre-processor 402 can include a text miner 408, a level analyzer 410, a feature transformer 412, a feature aggregator 414, and/or a data merger 416 configured to assist in converting the raw claim intake data 404 into processed claim data 406.

The text miner 408 can use text recognition, natural language processing, and/or other techniques to analyze unstructured text in raw claim intake data 404. For example, an XML file or other type of raw claim intake data 404 can include one or more AVPs that include freeform text, such as a participant's freeform description of circumstances associated with an accident. The text miner 408 can accordingly analyze the freeform text to identify or infer information that may be relevant to other AVPs, and add such information to the other AVPs. As a non-limiting example, AVPs in the raw claim intake data 404 may not include information that directly indicates what time an accident occurred. However, a freeform written description of an accident in raw claim intake data 404 may state that “it was dark” or “I'd just left a restaurant where we had dinner.” The text miner 108 may be configured to infer from such natural language sentences that the accident occurred at night, and/or add a corresponding approximate or estimated time to an AVP associated with an accident time.

The level analyzer 410 can analyze data in the original raw claim intake data 404 and/or that has been identified or inferred by the text miner 408 from the original raw claim intake data 404, and can identify data relevant to the claim 102 at one or more levels. In some examples, the level analyzer 410 can generate separate XML files, tables, or other data files for different levels, based on data that the level analyzer 410 identifies as relevant to the different levels. The level analyzer 410 may identify separate tables or data files for different levels using the same unique identifier for the claim 102 as a whole, such that the data merger 416 can later recombine the tables or data files associated with a shared unique identifier for the claim 102.

As a non-limiting example, the level analyzer 410 may identify and/or separate data relevant to an automobile insurance claim 102 at a claim level, a vehicle level, a policy level, at a participant level, and/or at other levels. claim level data can include information relevant to the claim 102 as a whole. For example, claim level data may include an identifier or a party that submitted the claim 102, an identifier of the claim 102, and/other claim level data.

Vehicle level data can include information relevant to particular vehicles associated with the claim 102. For example, if the claim 102 is associated with a three-car accident, at the vehicle level the level analyzer 410 may identify information associated with a first vehicle, information associated with a second vehicle, and information associated with a third vehicle.

Policy level data can include information relevant to particular insurance policies associated with the claim 102. For example, the policy level data can include insurance coverage information, insurance policy numbers, and/or other policy level data. In some examples, if multiple parties associated with the claim 102 have different insurance policies, the policy level data can include information about the different insurance policies.

Participant level data can include information about one or more participants associated with the claim 102. Participants can include drivers, passengers, witnesses, body shops, or other entities. For example, for a multi-car accident, the participant level data can include names, contact information, and/or other data about a driver of a first car and about a driver of a second car.

The feature transformer 412 can perform mathematical operations, conversion operations, mapping operations, transformation operations, data sanitation, and/or other operations on data in the original raw claim intake data 404, and/or that has been identified or inferred by the text miner 408 from the original raw claim intake data 404. In some examples, the feature transformer 412 may perform operations on claim level data, vehicle level data, policy level data, and/or on participant level data identified by the level analyzer 410.

In some examples, the feature transformer 412 can convert values to different ranges, such as to normalize original values on a different scale or to convert percentages to a corresponding decimal value. In other examples, the feature transformer 412 can convert text values to corresponding numerical values. For example, the feature transformer 412 may convert “yes” or “no” text strings to corresponding “0” or “1” binary values. As another example, names of states in location information can be converted to corresponding numerical values, based on predefined maps that indicate a unique numerical value that corresponds to each state. For instance, mapping information may indicate that a value of “5” corresponds to the state of California, and the feature transformer 412 can accordingly use text data indicating that an accident occurred in California to generate corresponding numerical location data of “5.” As yet another example, numeric codes can be assigned to other types of values for AVPs. For instance, the feature transformer 412 can be configured to add a code of “1” to an AVP when the claim 102 is submitted by a customer of the insurance company, but add a code of “2” to that AVP if the claim 102 was instead submitted by a third-party claimant.

The feature aggregator 414 can generate values for AVPs based on combinations or aggregations of information in raw claim intake data 404, and/or that has been identified or inferred by the text miner 408 from the original raw claim intake data 404. In some examples, the feature aggregator 414 may combine or aggregate data at the claim level, vehicle level, policy level, and/or the participant level. As a non-limiting example, for a claim associated with a large automobile accident involving ten different vehicles, information about the ages of each individual vehicle may not be relevant to assigning the claim 102 to a group. Accordingly, the feature aggregator 414 may be configured to calculate an average age of the ten vehicles, identify the ages of the oldest and/or newest vehicle, and/or otherwise process the data such that relevant combined or aggregated data is kept for the rules engine 110 and/or the machine learning model 112. As another non-limiting example, the feature aggregator 414 may be configured to combine AVPs for two or more different types of data into one AVP. For example, the feature aggregator 414 may be configured to use certain values for certain combinations of values from other AVPs, determine a value of an AVP as a ratio of the value of one AVP divided by the value of another AVP, and/or otherwise combine or aggregate values.

The data merger 416 can combine data that has been processed the by text miner 408, level analyzer 410, feature transformer 412, feature aggregator 414 into final processed claim data 406. As discussed above, the level analyzer 410 may have identified claim level data, vehicle level data, policy level data, and/or participant level data within the raw claim intake data 404. The feature transformer 412 and/or feature aggregator 414 may have accordingly operated on the claim level data, vehicle level data, policy level data, and/or participant level data separately. For example, feature transformer 412 and/or feature aggregator 414 may have operated on separate tables of data at the claim level, vehicle level, policy level, and/or participant level. Accordingly, the data merger 416 can merge or combine the transformed claim level data, vehicle level data, policy level data, and/or participant level data back into a single table or file, such as an XML file, JSON file, or other type of file. The file generated by the data merger 416 can be provided to the rules engine 110 and/or one or more machine learning models as processed claim data 406 that contains information in one or more formats that are compatible and/or interpretable by the rules engine 110 and/or the one or more machine learning models. In some examples, the data merger 416 or other elements of the claim data pre-processor 402 can generate processed claim data 406 in the same or different formats for the rules engine 110 and the one or more machine learning models.

The rules engine 110 and/or one or more machine learning models can be configured to use the processed claim data 406 as claim intake data 108 associated with the claim. Accordingly, the rules engine 110 can use the processed claim data 406 as claim intake data 108 to generate the rules engine assignment recommendation 114 as discussed above with respect to FIGS. 1 and 2. Similarly, one or more machine learning models, such as the machine learning model 112, can use the processed claim data 406 as claim intake data 108 to generate one or more corresponding machine learning assignment recommendations as discussed above with respect to FIGS. 1 and 3.

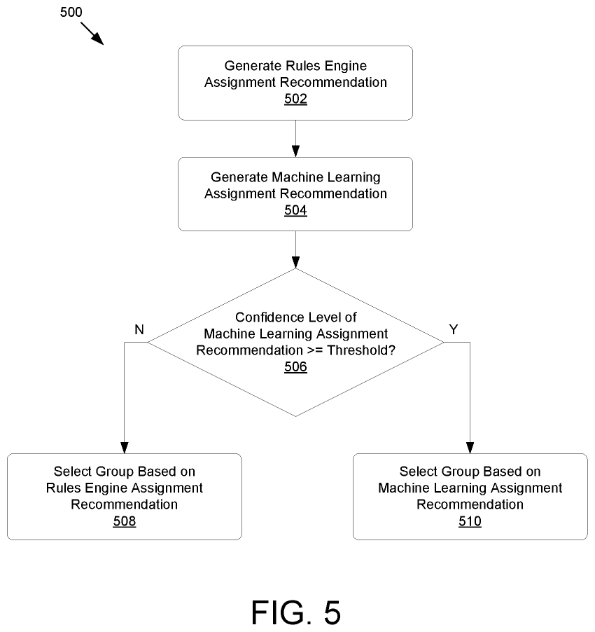

The assignment selector 120 of the claim assignment system 100 can in turn receive the rules engine assignment recommendation 114 and one or more machine learning assignment recommendations for the claim 102. The assignment selector 120 can also determine whether to follow the rules engine assignment recommendation 114, or one of the machine learning assignment recommendations, to select a group for the claim 102, for instance using one of the methods discussed below with respect to FIGS. 5-7.

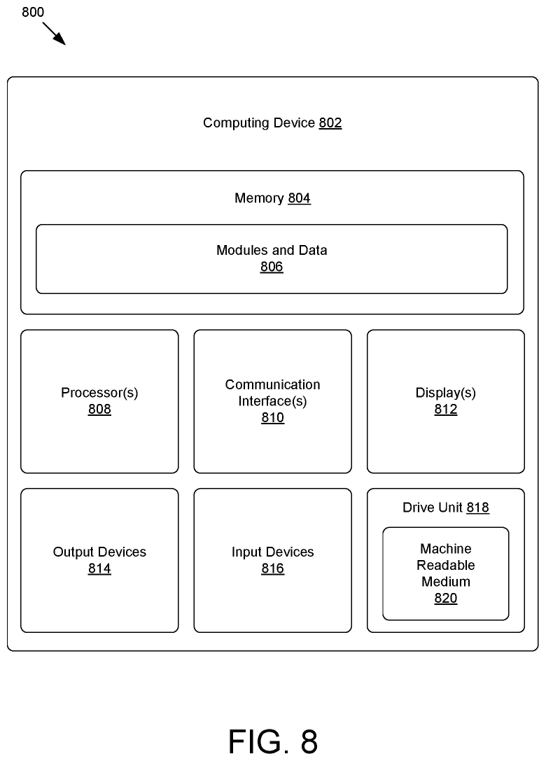

FIG. 5 shows a flowchart illustrating a first example method 500 for selecting a group for the claim 102. The method 500 shown in FIG. 5 can be executed by one or more computing devices associated with the claim assignment system 100. An example system architecture for such a computing device associated with the claim assignment system 100 is described below with respect to FIG. 8.

At block 502, the rules engine 110 can use the claim intake data 108 associated with the claim 102 to generate the rules engine assignment recommendation 114 that identifies a first recommended group to which the claim 102 can be assigned. At block 504, the machine learning model 112 can also use the claim intake data 108 associated with the claim 102 to generate the machine learning assignment recommendation 116 that identifies a second recommended group to which the claim 102 can be assigned, along with the corresponding confidence level 118.

The claim intake data 108 used by the rules engine 110 and the machine learning model 112 at block 502 and block 504 can originate from the claim intake system 106, as discussed above. In some examples, the claim data pre-processor 402 can operate on the claim intake data 108 before the claim intake data 108 is provided to the rules engine 110 and/or the machine learning model 112, as discussed above with respect to FIG. 4. The claim assignment system 100 can perform block 502 and block 504 in any order, and/or substantially in parallel with one another.

The machine learning assignment recommendation 116 generated at block 504 can include, or be associated with, the confidence level 118. In some examples, as discussed above with respect to FIG. 3, the machine learning model 112 may generate different confidence levels 304 associated with different candidate groups 104 to which the claim 102 can be assigned, for instance based on percentages of neurons of one or more layers of a neural network that predict each candidate group as the best destination for the claim 102. The machine learning model 112 can accordingly generate the machine learning assignment recommendation 116 to include information identifying the group that is associated with the highest of the confidence levels 304 among the candidate groups 104. The machine learning model 112 can also indicate the confidence level associated with the identified group as the confidence level 118 in, or with, the machine learning assignment recommendation 116. In other examples, the machine learning model 112 may generate a single prediction of the best group to handle the claim 102, and can identify that group in the machine learning assignment recommendation 116 along with the confidence level 118 associated with the prediction.

At block 506, the assignment selector 120 can determine if the confidence level 118 associated with the machine learning assignment recommendation 116 meets or exceeds a corresponding threshold value. In some examples, the threshold value can be static and/or predefined value for all machine learning assignment recommendations, such as 80%, 85%, 90%, 95%, or any other value. In other examples, the threshold value can vary based on the group identified in the machine learning assignment recommendation 116. As a non-limiting example, the assignment selector 120 may be configured with a threshold value of 95% associated with a “express” tier group, a threshold value of 85% associated with a “tier 1” group, and a threshold value of 80% associated with a “tier 2” group. Accordingly, if the machine learning assignment recommendation 116 identifies the “express” tier group, at block 506 the assignment selector 120 may determine if the confidence level 118 of the machine learning assignment recommendation 116 meets or exceeds the 95% threshold level associated with the “express” tier group. If the machine learning assignment recommendation 116 instead identifies the “tier 1” group or the “tier 2” group, at block 506 the assignment selector 120 may determine if the confidence level 118 of the machine learning assignment recommendation 116 meets or exceeds the lower threshold level associated with the “tier 1” group or the “tier 2” group.

If the assignment selector 120 determines at block 506 that the confidence level 118 associated with the machine learning assignment recommendation 116 is lower than a corresponding threshold value (Block 506—No), the assignment selector 120 can determine that the rules engine assignment recommendation 114 should be followed. Accordingly, the claim assignment system 100 can, at block 508, select the group for the claim 102 that is identified in the rules engine assignment recommendation 114.

However, if the assignment selector 120 determines at block 506 that the confidence level 118 associated with the machine learning assignment recommendation 116 meets or exceeds the corresponding threshold value (Block 506—Yes), the assignment selector 120 can determine that the machine learning assignment recommendation 116 should be followed. Accordingly, the claim assignment system 100 can, at block 510, select the group for the claim 102 that is identified in the machine learning assignment recommendation 116.

In some examples, the assignment selector 120 can assign the claim 102 to the group selected at block 508 or block 510. In other examples, the assignment selector 120 can output a notification or other indication of the group selected for the claim 102 at block 508 or block 510 to another element of the claim assignment system 100, and/or an outside system that requested an indication of which group the claim assignment system 100 selects for the claim 102.

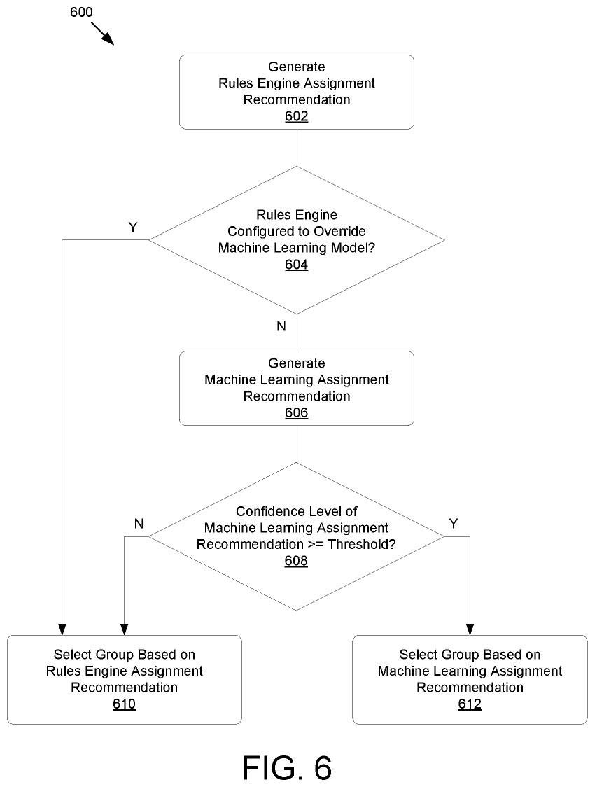

Overall, the claim assignment system 100 can use the method 500 shown in FIG. 5 to select groups 104 for claims based on rules engine assignment recommendations, unless corresponding machine learning assignment recommendations have confidence levels that are at or above one or more threshold values. However, in other examples, the claim assignment system 100 may be configured to at least temporarily use rules engine assignment recommendations to select groups for some or all types of claims instead of machine learning assignment recommendations, as discussed below with respect to FIG. 6.

FIG. 6 shows a flowchart illustrating a second example method 600 for selecting a group for the claim 102. The method 600 shown in FIG. 6 can be executed by one or more computing devices associated with the claim assignment system 100. An example system architecture for such a computing device associated with the claim assignment system 100 is described below with respect to FIG. 8.

At block 602, the rules engine 110 can use the claim intake data 108 associated with the claim 102 to generate the rules engine assignment recommendation 114 that identifies a first recommended group to which the claim 102 can be assigned. The claim intake data 108 used by the rules engine 110 at block 602 can originate from the claim intake system 106, as discussed above. In some examples, the claim data pre-processor 402 can operate on the claim intake data 108 before the claim intake data 108 is provided to the rules engine 110, as discussed above with respect to FIG. 4.

At block 604, the claim assignment system 100 can determine if the rules engine 110 has been configured to at least temporarily override the machine learning model 112. In some examples, the claim assignment system 100 may have been adjusted to at least temporarily use rules engine assignment recommendations, instead of machine model assignment recommendations, for all types of claims or for the type of claim associated with the claim intake data 108, for instance based on a recent change to the rules engine 110. The rules engine 110 may have been modified to adjust a rule, change a rule, delete a rule, or otherwise change how the rules engine 110 generates rules engine assignment recommendations to account for new types of claims, claims associated with natural disasters or other events, changes in groups 104, and/or other factors. Accordingly, if the machine learning model 112 has not yet been trained to assign claims to groups 104 based on the changes to the rules engine 110, the insurance company or other entity that operates the claim assignment system 100 can configure the rules engine 110 to at least temporarily override the machine learning model 112 in the claim assignment system 100. In some examples, the insurance company or other entity may configure the assignment selector 120 to at least temporarily assign claims based on rules engine assignment recommendations instead of machine learning assignment recommendations, and thus indirectly configure the rules engine 110 to override the machine learning model 112 at the assignment selector 120. In some examples, the claim assignment system 100 can be set to temporarily override the machine learning model 112 with the rules engine 110 by default for certain types of claims, but not for other types of claims.

If the claim assignment system 100 determines at block 604 that the rules engine 110 has not been configured to override the machine learning model 112 (Block 604—No), the machine learning model 112 can generate the machine learning assignment recommendation 116 for the claim 102 at block 606, for example as discussed above with respect to block 504 of FIG. 5. At block 608, the assignment selector 120 can determine if the confidence level 118 of the machine learning assignment recommendation 116 meets or exceeds a corresponding threshold value, as discussed above with respect to block 506 of FIG. 5. If the confidence level 118 associated with the machine learning assignment recommendation 116 is lower than a corresponding threshold value (Block 608—No), the claim assignment system 100 can assign the claim 102 to the group identified in the rules engine assignment recommendation 114 at block 610, as discussed above with respect to block 508 of FIG. 5. If the confidence level 118 associated with the machine learning assignment recommendation 116 meets or exceeds the corresponding threshold value (Block 608—Yes), the claim assignment system 100 can select the group for the claim 102 that is identified in the machine learning assignment recommendation 116 at block 612, as discussed above with respect to block 510 of FIG. 5.

However, if the claim assignment system 100 determines at block 604 that the rules engine 110 has been configured to override the machine learning model 112 overall or for the current type of claim (Block 604—Yes), the claim assignment system 100 can, at block 610, assign the claim 102 to the group identified in the rules engine assignment recommendation 114. Over time, as claims are assigned according to rules engine assignment recommendations during a period of time in which the rules engine 110 overrides the machine learning model 112, those assignments of claims to groups 104 can be used as new training data to re-train the machine learning model 112. When the machine learning model 112 has been re-trained based on the new training data, the claim assignment system 100 can be reconfigured not to override the machine learning model 112 with the rules engine 110 by default, and the assignment selector 120 can determine whether to follow machine learning assignment recommendations or rules engine assignments at block 608 based on confidence levels of the machine learning assignment recommendations.

In alternate examples, block 604 can be absent, such that the claim assignment system 100 generates the rules engine assignment recommendation 114 at block 602 and also generates the machine learning assignment recommendation 116 at block 606. However, at block 608, the assignment selector 120 can be configured to determine if the rules engine 110 added an override flag, or other override indicator, to the rules engine assignment recommendation 114. If such an override flag, or other override indicator, is present in the rules engine assignment recommendation 114, the assignment selector 120 can determine that the confidence level 118 of the machine learning assignment recommendation 116 does not meet or exceed a threshold, regardless of the actual confidence level 118 of the of the machine learning assignment recommendation 116. The claim assignment system 100 can accordingly move to block 610 and select the group for the claim 102 that is identified in the rules engine assignment recommendation 114, based on the presence of an override indicator in the rules engine assignment recommendation 114, regardless of the confidence level 118 of the of the machine learning assignment recommendation 116.

Accordingly, the method 600 can allow an entity to adjust the rules engine 110 for one or more types of claims, and cause the claim assignment system 100 to follow rules engine assignment recommendations produced by the rules engine 110 in certain situations and/or until the machine learning model 112 can be retrained based on new rules engine assignment recommendations generated based on the adjustments to the rules engine 110.

In some examples, the assignment selector 120 can assign the claim 102 to the group selected at block 610 or block 612. In other examples, the assignment selector 120 can output a notification or other indication of the group selected for the claim 102 at block 610 or block 612 to another element of the claim assignment system 100, and/or an outside system that requested an indication of which group the claim assignment system 100 selects for the claim 102.

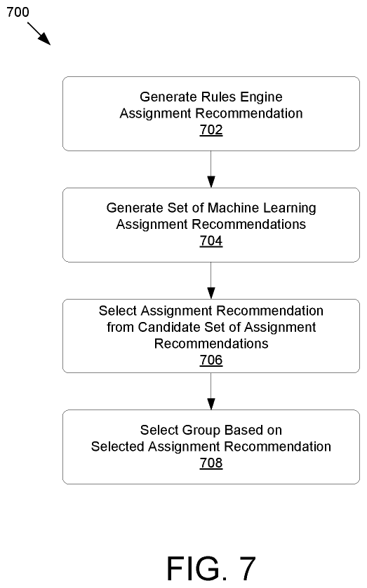

While FIG. 5 and FIG. 6 show examples in which the claim assignment system 100 chooses between two assignment recommendations, generated by the rules engine 110 and the machine learning model 112, in other examples the claim assignment system 100 can have multiple machine learning models that each generate distinct assignment recommendations. The claim assignment system 100 can be configured to select one of a candidate set of assignment recommendations generated by the rules engine 110 and multiple machine learning models, as discussed below with respect to FIG. 7.

FIG. 7 shows a flowchart illustrating a third example method 700 for selecting a group for the claim 102. The method 700 shown in FIG. 5 can be executed by one or more computing devices associated with the claim assignment system 100. An example system architecture for such a computing device associated with the claim assignment system 100 is described below with respect to FIG. 8.

At block 702, the rules engine 110 can use the claim intake data 108 associated with the claim 102 to generate the rules engine assignment recommendation 114 that identifies a recommended group to which the claim 102 can be assigned.

At block 704, multiple machine learning models can also use the claim intake data 108 associated with the claim 102 to generate a set of machine learning assignment recommendations. Each of the machine learning models can generate a distinct machine learning assignment recommendation, such as the machine learning assignment recommendation 116, that identifies a recommended group to which the claim 102 can be assigned, along with a corresponding confidence level.

The claim intake data 108 used by the rules engine 110 and the machine learning models at block 702 and block 704 can originate from the claim intake system 106, as discussed above. In some examples, the claim data pre-processor 402 can operate on the claim intake data 108 before the claim intake data 108 is provided to the rules engine 110 and/or the machine learning models, as discussed above with respect to FIG. 4. The claim assignment system 100 can perform block 702 and block 704 in any order, and/or substantially in parallel with one another.

At block 706, the assignment selector 120 can select an assignment recommendation from a candidate set of assignment recommendations that includes the rules engine assignment recommendation 114 generated at block 702 and the set of machine learning assignment recommendations generated at block 704. For example, the assignment selector 120 can perform one or more comparison operations at block 706 to compare the rules engine assignment recommendation 114 against one or more of the machine learning assignment recommendations, to determine if any of the machine learning assignment recommendations have confidence levels above associated threshold values such that the machine learning assignment recommendations should be selected over the rules engine assignment recommendation 114 as discussed above with respect to FIG. 5.

In some examples, the assignment selector 120 can be configured to select an assignment recommendation at block 706 based on performing comparison operations associated with a predefined hierarchy of the machine learning models and/or the rules engine 110. As a non-limiting example, the assignment selector 120 can be configured to select a machine learning assignment recommendation produced by a machine learning model that is highest in the hierarchy, if that machine learning assignment recommendation has a confidence level that is above a corresponding threshold. However, the assignment selector 120 can be configured to otherwise select one of the other machine learning assignment recommendations produced by a machine learning model that is lower in the hierarchy, if the machine learning assignment recommendation exceeds the same or a different threshold, or to select the rules engine assignment recommendation 114 if none of the machine learning assignment recommendations have confidence levels above corresponding thresholds.

At block 708, the assignment selector 120 can select the group for the claim 102 that is identified in the assignment recommendation selected at block 706. In some examples, the assignment selector 120 can assign the claim 102 to the group selected at block 708. In other examples, the assignment selector 120 can output a notification or other indication of the group selected for the claim 102 at block 708 to another element of the claim assignment system 100, and/or an outside system that requested an indication of which group the claim assignment system 100 selects for the claim 102.

FIG. 8 shows an example system architecture 800 for a computing device 802 associated with the claim assignment system 100 described herein. The computing device 802 can be a server, computer, or other type of computing device that executes one or more portions of the claim assignment system 100, such as the claim intake system 106, the rules engine 110, the machine learning model 112, other machine learning models, the assignment selector 120, and/or the claim data pre-processor 402. In some examples, elements of the claim assignment system 100 can be distributed among, and/or be executed by, multiple computing devices similar to the computing device shown in FIG. 8. For example, the rules engine 110 may execute on a different computing device than the machine learning model 112.

The computing device 802 can include memory 804. In various examples, the memory 804 can include system memory, which may be volatile (such as RAM), non-volatile (such as ROM, flash memory, etc.) or some combination of the two. The memory 804 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing device 802 associated with the claim assignment system 100. Any such non-transitory computer-readable media may be part of the computing device 802.

The memory 804 can store modules and data 806. The modules and data 806 can include one or more of the claim intake system 106, the claim intake data 108, the rules engine 110, the machine learning model 112, other machine learning models, the rules engine assignment recommendation 114, the machine learning assignment recommendation 116, the assignment selector 120, the claim data pre-processor 402, and/or other elements described herein. Additionally, or alternately, the modules and data 806 can include any other modules and/or data that can be utilized by the claim assignment system 100 to perform or enable performing any action taken by the claim assignment system 100. Such other modules and data can include a platform, operating system, and applications, and data utilized by the platform, operating system, and applications.

The computing device 802 associated with the claim assignment system 100 can also have processor(s) 808, communication interfaces 810, display 812, output devices 814, input devices 816, and/or a drive unit 818 including a machine readable medium 820.

In various examples, the processor(s) 808 can be a central processing unit (CPU), a graphics processing unit (GPU), both a CPU and a GPU, or any other type of processing unit. Each of the one or more processor(s) 808 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 808 may also be responsible for executing computer applications stored in the memory 804, which can be associated with common types of volatile (RAM) and/or nonvolatile (ROM) memory.

The communication interfaces 810 can include transceivers, modems, interfaces, antennas, telephone connections, and/or other components that can transmit and/or receive data over networks, telephone lines, or other connections.

The display 812 can be a liquid crystal display, or any other type of display commonly used in computing devices. For example, a display 812 may be a touch-sensitive display screen, and can then also act as an input device or keypad, such as for providing a soft-key keyboard, navigation buttons, or any other type of input.

The output devices 814 can include any sort of output devices known in the art, such as a display 812, speakers, a vibrating mechanism, and/or a tactile feedback mechanism. Output devices 814 can also include ports for one or more peripheral devices, such as headphones, peripheral speakers, and/or a peripheral display.

The input devices 816 can include any sort of input devices known in the art. For example, input devices 816 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 820 can store one or more sets of instructions, such as software or firmware, that embodies any one or more of the methodologies or functions described herein. The instructions can also reside, completely or at least partially, within the memory 804, processor(s) 808, and/or communication interface(s) 810 during execution thereof by the computing device 802 associated with the claim assignment system 100. The memory 804 and the processor(s) 808 also can constitute machine readable media 820.

Overall, one or more machine learning models can be trained to generate machine learning assignment recommendations for claims that may more accurately reflect final groups 104 that the claims are assigned to when the groups 104 begin processing the claims. For example, while the rules engine 110 may use static rules to identify groups to which claims can be assigned, in practice such claims are often reassigned to other groups 104. However, as described herein, if a machine learning assignment recommendation for the claim 102 recommends a different group than the rules engine assignment recommendation 114, and a confidence level of the machine learning assignment recommendation meets or exceeds a threshold value, the machine learning assignment recommendation may be more likely to identify the group that will ultimately process the claim 102.

Accordingly, by directly assigning the claim 102 to that identified group initially, based on the machine learning assignment recommendation, delays and inefficiencies associated with reassigning the claim 102 can be avoided. For example, network bandwidth usage associated with transferring or reassigning claims between groups can be lowered, processing cycles, memory usage, and/or other computing resources associated with groups that do not ultimately process claims can be saved, and/or claims can be processed more quickly.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A method, comprising:
obtaining, by a claim assignment system, claim intake data associated with an insurance claim;
generating, by a rules engine of the claim assignment system based on the claim intake data, a rules engine assignment recommendation indicating a first group of workers;
generating, by a machine learning model of the claim assignment system based on the claim intake data, a machine learning assignment recommendation indicating a second group of workers and a confidence level associated with the machine learning assignment recommendation;
determining, by the claim assignment system, that the confidence level meets or exceeds a threshold value; and
selecting, by the claim assignment system, the second group for the insurance claim, based on determining that the confidence level meets or exceeds the threshold value.

2. The method of claim 1, further comprising training, by the claim assignment system, the machine learning model using historical data associated with previous insurance claims assigned among a candidate set of groups.

3. The method of claim 2, wherein the historical data identifies groups that the previous insurance claims were assigned to when the groups began taking substantive actions to process the previous insurance claims.

4. The method of claim 1, wherein the machine learning model is a neural network configured to:
generate a set of confidence levels corresponding to a set of candidate groups;
select a candidate group associated with a highest confidence level in the set of confidence levels;
identify the candidate group as the second group in the machine learning assignment recommendation; and
identify the highest confidence level as the confidence level associated with the machine learning assignment recommendation.

5. The method of claim 1, wherein the first group and the second group are selected from a candidate set of groups associated with one or more of different worker skill levels, different claim types, or different claim processing issues.

6. The method of claim 1, further comprising:
obtaining, by the claim assignment system, second claim intake data associated with a second insurance claim;
generating, by the rules engine based on the second claim intake data, a second rules engine assignment recommendation indicating a third group of workers;
determining, by the claim assignment system, that the rules engine is configured to at least temporarily override the machine learning model for a claim type of the second insurance claim; and
selecting, by the claim assignment system, the third group for the second insurance claim, based at least in part on determining that the rules engine is configured to at least temporarily override the machine learning model.

7. The method of claim 6, further comprising training the machine learning model at least in part using information about assignments of a set of insurance claims based on a set of rules engine assignment recommendations generated during a period of time in which the rules engine is configured to at least temporarily override the machine learning model.

8. The method of claim 1, further comprising:
processing, by the claim assignment system, the claim intake data separately at two or more of:
a claim level associated with the insurance claim as a whole,
a vehicle level associated with one or more vehicles associated with the insurance claim,
a policy level associated with one or more insurance policies associated with the insurance claim, or
a participant level associated with one or more participants associated with the insurance claim;
combining data processed at the two or more of the claim level, the vehicle level, the policy level, and the participant level into processed claim intake data; and
providing the processed claim intake data to one or more of the rules engine and the machine learning model as the claim intake data.

9. The method of claim 1, wherein the machine learning model is a first machine learning model and the machine learning assignment recommendation is a first machine learning assignment recommendation, the method further comprising:
generating, by a second machine learning model of the claim assignment system, a second machine learning assignment recommendation indicating a third group of workers and a second confidence level associated with the second machine learning assignment recommendation; and
selecting, by the claim assignment system, the first machine learning assignment recommendation over the second machine learning assignment recommendation based on a predefined hierarchy of the first machine learning model and the second machine learning model,
wherein the claim assignment system selects the second group for the insurance claim based at least in part on selecting the first machine learning assignment recommendation over the second machine learning assignment recommendation.

10. The method of claim 1, further comprising assigning the insurance claim to the second group, in response to selecting the second group.

11. A claim assignment system, comprising:
a claim intake system configured to obtain claim intake data associated with an insurance claim;
a rules engine configured to generate, based on the claim intake data, a rules engine assignment recommendation indicating a first group of workers;
a machine learning model configured to generate, based on the claim intake data, a machine learning assignment recommendation indicating a second group of workers and a confidence level associated with the machine learning assignment recommendation; and
an assignment selector configured to:
determine that the confidence level meets or exceeds a threshold value;
select the second group, based on determining that the confidence level meets or exceeds the threshold value; and
output an indication that the insurance claim is to be assigned to the second group.

12. The claim assignment system of claim 11, wherein the machine learning model is trained based on historical data about previous insurance claims assigned among a candidate set of groups.

13. The claim assignment system of claim 11, wherein the machine learning model is a neural network configured to:
generate a set of confidence levels corresponding to a set of candidate groups, and
select a candidate group associated with a highest confidence level in the set of confidence levels;
identify the candidate group as the second group in the machine learning assignment recommendation; and
identify the highest confidence level as the confidence level associated with the machine learning assignment recommendation.

14. The claim assignment system of claim 11, wherein the first group and the second group are selected from a candidate set of groups associated with one or more of different worker skill levels, different claim types, or different claim processing issues.

15. The claim assignment system of claim 11, further comprising:
a second machine learning model configured to generate, based on the claim intake data, a second machine learning assignment recommendation indicating a third group of workers and a second confidence level associated with the second machine learning assignment recommendation,
wherein the assignment selector is configured to select the second group based at least in part on determining that the machine learning model is higher, in a predetermined hierarchy, than the second machine learning model.

16. One or more non-transitory computer-readable media storing computer-executable instructions that, when executed by one or more processors, cause the one or more processors to perform operations comprising:
generating, by a rules engine, and based on claim intake data associated with an insurance claim, a rules engine assignment recommendation indicating a first group selected from a set of candidate groups;
generating, by a machine learning model, and based on the claim intake data, a machine learning assignment recommendation indicating:
a second group selected from the set of candidate groups; and
a confidence level;
determining that the confidence level meets or exceeds a threshold value; and
selecting the second group for the insurance claim, based on determining that the confidence level meets or exceeds the threshold value.

17. The one or more non-transitory computer-readable media of claim 16, wherein the operations further comprise training the machine learning model using historical data about previous insurance claims assigned among the set of candidate groups.

18. The one or more non-transitory computer-readable media of claim 16, wherein the machine learning model is a neural network configured to:
generate a set of confidence levels corresponding to the set of candidate groups, and
select a candidate group associated with a highest confidence level in the set of confidence levels;
identify the candidate group as the second group in the machine learning assignment recommendation; and
identify the highest confidence level as the confidence level associated with the machine learning assignment recommendation.

19. The one or more non-transitory computer-readable media of claim 16, wherein the operations further comprise:
obtaining second claim intake data associated with a second insurance claim;
generating, based on the second claim intake data, a second rules engine assignment recommendation indicating a third group selected from the set of candidate groups;
determining that the rules engine is configured to at least temporarily override the machine learning model for a claim type of the second insurance claim; and
selecting the third group for the second insurance claim, based at least in part on determining that the rules engine is configured to at least temporarily override the machine learning model.

20. The one or more non-transitory computer-readable media of claim 16, wherein the operations further comprise:
generating, by a second machine learning model, and based on the claim intake data, a second machine learning assignment recommendation indicating:
a third group selected from the set of candidate groups; and
a second confidence level; and
selecting the machine learning assignment recommendation over the second machine learning assignment recommendation based on a predefined hierarchy of the machine learning model and the second machine learning model,
wherein selecting the second group for the insurance claim is further based, at least in part, on selecting the machine learning assignment recommendation over the second machine learning assignment recommendation.
